(19) United States
(12) Patent Application Publication
(10) Pub. No.: US 2010/0135395 A1
(43) Pub. Date: Jun. 3, 2010

(54) EFFICIENT SPATIO-TEMPORAL VIDEO UP-SCALING

(76) Inventors: Marc Paul Servais, Reading (GB); Andrew Kay, Oxford (GB)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/327,011

(22) Filed: Dec. 3, 2008

(51) Int. Cl. H04N 7/32

(52) U.S. Cl. 375/240.16; 375/E07.123

(57) ABSTRACT

A method of performing spatio-temporal up-scaling includes receiving an input video having a sequence of input frames, analyzing the input video to estimate motion vectors associated with the sequence of input frames, and determining corresponding motion compensation errors associated with the motion vectors. The method further includes determining an extent to which computational resources are to be respectively allocated to spatially up-scaling the sequence of input frames and temporally up-scaling the sequence of input frames, based on the estimated motion vectors and corresponding motion compensation errors. In addition, the method includes spatio-temporally up-scaling the sequence of input frames based on the determined extent.

### TECHNICAL FIELD

The present invention relates generally to spatial and temporal scaling, and more particularly to spatio-temporal up-scaling of video data.

### BACKGROUND OF THE INVENTION

Spatial scaling allows images to be changed in size (spatial resolution), while temporal scaling (also known as frame rate conversion, or frame interpolation) changes the frame rate (temporal resolution) of video. Although these techniques are often used individually, hybrid spatio-temporal scaling is also possible. Applications include video format conversion and the scaling of input video to match a display's frame rate and spatial resolution properties.

There is a substantial amount of literature describing both spatial and temporal scaling methods. In the case of electronic displays, spatial scaling is commonly used to match the size of an input image to that of the display. Temporal scaling (also known as frame rate conversion or FRC) is often used to provide increased resolution and smoother (less juddery) motion.

Spatial and temporal scaling are usually performed as separate processes, however combined spatio-temporal scaling techniques are also possible, and are sometimes used in the context of scalable video coding and video streaming.

Given a video source at particular spatial resolution and frame rate, the goal of scalable video coding is to produce a single compressed file (or bit-stream) from which a video can be decoded at a range of spatial and temporal resolutions that are lower than (or equal to) the original resolution. See, for example, “Advanced Video Coding for Generic Audiovisual Services”, ITU-T Rec. H.264 and ISO/IEC 14496-10 (MPEG-4 AVC), ITU-T and ISO/IEC JTC 1, Version 8 including the Scalable Video Coding (SVC) extension, July 2007.

Scalable video coding is useful when a single source (e.g. one compressed bit-stream) is broadcast to many devices. In this scenario, a decoder with limited computational resources would be able to decode a subset of the original bit-stream in order to generate video output, though at a lower quality. Similarly, a decoder connected to a small display would not need to decode the entire bit-stream, but could extract and decode that portion of it required to generate a low-resolution output that matches the display size.

Video streaming applications operate in an environment where bandwidth is often limited. In this case the network may seek to control packet loss by discarding data that minimizes the resulting reduction in picture quality. Thus some frames may be dropped, or packets describing fine detail may be discarded when a network becomes congested. This type of network-based “throttling” of streaming video allows the network to perform spatial, temporal or spatio-temporal down-scaling in order to reduce the video bit-rate to a manageable one. It works best when video has been coded using a scalable video coding method.

In U.S. Pat. No. 6,108,047, a method and device for temporal and spatial scaling is described. Temporal scaling is performed using motion compensated frame interpolation, while spatial scaling is applied horizontally and vertically in a way that allows for both interlaced and progressive video to be processed. Although both temporal and spatial scaling are performed, they operate as independent, sequential processes.

U.S. Pat. No. 5,852,565 and U.S. Pat. No. 6,988,863 describe a method of video coding in which the video content is separated into spatio-temporal layers. A base layer with low temporal and spatial resolution is coded, followed by subsequent spatial and temporal refinement layers—each based on the MPEG-2 standard. During very rapid scene changes, bits are allocated to the base layer only.

In U.S. Pat. No. 5,821,986, a scalable approach to video coding is presented, in which a bit-stream is coded in a layered way so that higher-resolution information can be discarded should the network become congested. In addition, such an approach allows a decoder to decode at a lower resolution if it is computationally unable to decode high-resolution video data.

Scalable Video Coding has been standardised as part of the H.264/AVC video coding standard. (See, e.g., “Advanced Video Coding . . . ”, Id.; US2008/0130757; and U.S. Pat. No. 7,369,610). Such a technique enables the creation of embedded bit-streams, which allow the decoder to perform scaling in terms of frame rate, spatial resolution and quality (bit-depth).

Kuhmünch, et al., “A Video-Scaling Algorithm Based on Human Perception for Spatio-Temporal Stimuli” in Proceedings of SPIE, Multimedia Computing and Networking, pp. 13-24, San José, Calif., January 2001, and Akyol, et al., “Content-aware scalability-type selection for rate adaptation of scalable video” in EURASIP Journal on Applied Signal Processing, Volume 2007, Issue 1 (January 2007) pp. 214-214, consider the relationship between available bit-rate, video content and the type of spatio-temporal scaling to be used when generating a scalable bit-stream from a high-resolution video source. In particular, they investigate whether human observers prefer more spatial or temporal down-scaling for different types of scene content (when compared at the same overall bit-rate).

Kuhmünch, et al. use a measure of “motion energy” in order to drop frames (i.e. temporally down-scale) when there is little motion present in a scene. However, in scenes with fast motion, spatial down-scaling is performed more aggressively in order to maintain a high frame rate.

Akyol, et al. propose a cost function based on blockiness, flatness, blurriness and temporal judder. This cost function can be used to determine the appropriate mix of spatial, temporal and quality down-scaling in order to achieve a target bit-rate, while attempting to maximise the picture quality perceived by the human visual system at that bit-rate.

As outlined above, spatio-temporal scaling is known within the context of scalable video coding and video streaming over networks. In both of these cases its main purpose is to down-scale video data in such a way that the resulting loss in quality is minimised. However, there remains a strong need for a technique which provides increased video resolution in a high-quality, yet computationally-efficient manner.

### SUMMARY OF THE INVENTION

Applicants refer initially to commonly assigned U.K. Application No. GB0711390.5, entitled “Method of and Apparatus for Frame Rate Conversion” and filed on 13 Jun. 2007. Such application is directed to a method for performing frame rate conversion to a higher frame rate using motion compensation and frame repetition.

The present invention seeks further to provide high-quality, computationally-efficient, spatio-temporal up-scaling.

Due to limited computational resources, high-quality spatio-temporal scaling is often difficult to achieve. The current invention describes an efficient approach to spatio-temporal up-scaling of video, with computational resources allocated more optimally, and according to the spatio-temporal sensitivity of the human visual system.

In scenes with fast motion, the eye struggles to perceive fine detail in fast-moving objects. It may thus be beneficial to allocate more computational power to performing temporal scaling, with less of an emphasis on spatial scaling. This would help to eliminate the “juddery” motion that is sometimes observable at low frame rates, while not wasting processing power on enhancing detail that is not observable to the human eye.

Conversely, in slow moving-scenes, it is likely that there will be more to gain by devoting greater resources to the spatial scaling process. This should allow for a sharper, more detailed picture. Furthermore, the human visual system does not require very high frame rates for the accurate portrayal of slow motion. For sample-and-hold type displays (such as LCDs) the display is “always on” and consequently a high frame rate is not required for the accurate portrayal of slow motion. However, displays that flash each field/frame (such as CRTs or film projectors) can cause perceptible flicker if they flash too slowly. Thus a film projector will only show a new frame 24 times per second, but it will actually flash each of these frames two or three times in order to reduce flicker. Consequently, simple frame repetition is likely to be a sufficient method of temporal scaling for a scene with little or no motion.

According to the invention, the type of spatio-temporal scaling performed is preferably dependent on scene characteristics—in particular the speed of motion and the reliability of the motion vectors between frames. In general, the invention is implemented in order that:
The higher the speed of motion, the greater the bias toward motion-compensated interpolation when performing temporal scaling.
The lower the speed of motion, the greater the bias toward a high-quality method (possibly using multi-frame super-resolution techniques) when performing spatial scaling.
When motion vectors are considered unreliable, multi-frame motion-compensated methods are avoided for both spatial and temporal scaling.

According to an aspect the present invention, a method of performing spatio-temporal up-scaling is provided. The method includes receiving an input video having a sequence of input frames, analyzing the input video to estimate motion vectors associated with the sequence of input frames, and determining corresponding motion compensation errors associated with the motion vectors. The method further includes determining an extent to which computational resources are to be respectively allocated to spatially up-scaling the sequence of input frames and temporally up-scaling the sequence of input frames, based on the estimated motion vectors and corresponding motion compensation errors. In addition, the method includes spatio-temporally up-scaling the sequence of input frames based on the determined extent.

According to a particular aspect, when the motion vectors and corresponding motion compensation errors are indicative of relatively fast motion and small motion compensation error, the computational resources are biased towards temporal up-scaling.

In accordance with another aspect, when the motion vectors and corresponding motion compensation errors are indicative of relatively slow motion and small motion compensation error, the computational resources are biased towards spatial up-scaling.

According to yet another aspect, when the corresponding motion compensation errors are indicative of relatively large motion compensation error, the computational resources are biased towards spatial up-scaling.

In accordance with still another aspect, the extent is determined frame-by-frame for the sequence of input frames.

In yet another aspect, the extent is determined region-by-region within a given frame in the sequence of input frames.

According to still another aspect, the motion vectors are estimated using at least one of block matching, phase correlation and gradient-based techniques.

In still another aspect, the computational resources are biased towards temporal up-scaling by applying motion-compensated frame interpolation for temporal up-scaling, and at least one of bicubic or bilinear scaling for spatial up-scaling, in the spatio-temporal up-scaling step.

According to another aspect, the computational resources are biased towards spatial up-scaling by applying multi-frame super resolution for spatial up-scaling, and frame repetition for temporal up-scaling, in the spatio-temporal up-scaling step.

In accordance with another aspect, the computational resources are biased towards spatial up-scaling by applying single-frame spatial up-scaling for spatial up-scaling, and frame repetition for temporal scaling, in the spatio-temporal up-scaling step.

Regarding still another aspect, the determining step includes selecting a spatio-temporal up-scaling mode for the spatio-temporal up-scaling step from among a plurality of different predefined spatio-temporal up-scaling modes, based on the estimated motion vectors and corresponding motion compensation errors.

In accordance with another aspect, each of the plurality of different predefined spatio-temporal up-scaling modes includes a different combination of spatial up-scaling and temporal up-scaling methods.

With respect to another aspect, at least one of the plurality of different predefined spatio-temporal up-scaling modes utilizes motion estimation for at least one of spatial up-scaling and temporal up-scaling, and another of the plurality of different predefined spatio-temporal up-scaling modes does not utilize motion estimation.

According to another aspect, selection between the at least one predefined spatio-temporal up-scaling mode and the another predefined spatio-temporal up-scaling mode is based on whether the corresponding motion compensation error exceeds a predefined error threshold value.

In accordance with still another aspect, the corresponding motion compensation errors associated with the motion vectors are calculated using at least one of mean square error and mean absolute difference techniques.

In accordance with yet another aspect, the analyzing step includes calculating a motion speed metric using the motion vectors, and selection between the different predefined spatio-temporal up-scaling modes is based on whether the corresponding motion speed metric exceeds a predefined speed threshold value.

According to another aspect, the motion speed metric is based on at least one of average motion, maximum motion and maximum motion vector gradient of motion vectors in a given frame or region within the sequence of input frames.

In accordance with another aspect of the invention, a computer program including code stored on a computer-readable medium is provided which, when executed by a computer, causes the computer to carry out the steps of receiving an input video comprising a sequence of input frames, analyzing the input video to estimate motion vectors associated with the sequence of input frames, and determining corresponding motion compensation errors associated with the motion vectors. Moreover, an extent is determined to which computational resources are to be respectively allocated to spatially up-scaling the sequence of input frames and temporally up-scaling the sequence of input frames, based on the estimated motion vectors and corresponding motion compensation errors; and spatio-temporally up-scaling of the sequence of input frames is performed based on the determined extent.

According to another aspect of the invention, a method of performing spatio-temporal up-scaling is provided which includes receiving an input video data comprising a sequence of input frames; performing a combination of spatial up-scaling and temporal up-scaling to the sequence of input frames; and modifying the combination dynamically as a function of at least one property of the sequence of input frames.

Still further, according to another aspect the at least one property comprises motion exhibited in the sequence of input frames.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 illustrates spatio-temporal up-scaling with motion estimation performed between frames in the original (input video) sequence.

FIG. 2 outlines a spatio-temporal scaling process in accordance with an embodiment of the invention. Input frames are scaled both temporally and spatially in one of three different ways—according to the motion characteristics of the scene.

FIG. 3 provides a graphical illustration of the three spatio-temporal scaling modes in accordance with an embodiment of the invention, whereby the three modes are a function of the speed of motion and motion compensation error (or motion vector unreliability).

FIG. 4 depicts the calculation of the appropriate spatio-temporal scaling mode in more detail according to an embodiment of the invention, and in particular, how the motion compensation error metric and the speed of motion metric are calculated.

FIG. 5 shows how the motion vector gradient is calculated for each block in a frame according to an embodiment of the invention. Note that there is one motion vector per block.

### DETAILED DESCRIPTION OF THE INVENTION

The present invention provides a method to enable high-quality spatio-temporal scaling in a computationally efficient manner. For a given set of spatial and temporal scaling factors, the objective is to choose a spatio-temporal scaling method that maximises the perceptual image quality, while not exceeding the available computational resources.

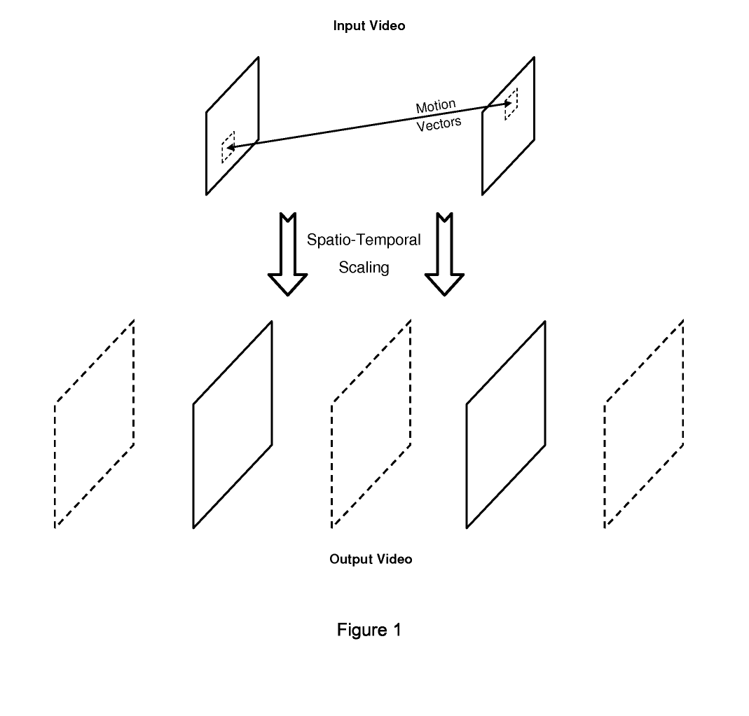

Spatio-temporal up-scaling involves increasing both the spatial and temporal resolution of video. For digital images, this amounts to increasing the number of samples (pixels) in each frame, and also increasing the number of frames per second. FIG. 1 provides a basic illustration of the spatio-temporal up-scaling process. Increasing the spatial resolution helps to provide a sharper, more detailed picture; and increasing the temporal resolution allows for motion to be represented more smoothly.

Motion estimation is often used when performing temporal scaling. In order to generate new frames between existing ones, it is necessary to estimate the position of objects within the scene at an intermediate point in time. Motion information can also be used for spatial scaling: multi-frame super-resolution methods align regions in neighbouring frames with those in the current frame so that information from several (aligned) frames can be combined to provide extra detail in the up-scaled frame.

Motion estimation can be performed in many ways, with the most popular being block matching, phase correlation and gradient-based methods. In the exemplary embodiment, the present invention utilizes block matching, phase correlation and/or gradient-based methods, although it will be appreciated that other known ways for performing motion estimation may be utilized without departing from the scope of the invention. The motion estimation process produces a collection of motion vectors which represent the direction and speed of motion in the scene (See FIG. 1). Usually there is one motion vector per block (or region), although dense vectors (i.e. one per pixel) are also possible. Each motion vector has a motion compensation error value associated with it. The greater this error, the more unreliable the corresponding motion vector is likely to be.

In order to use motion vectors effectively for spatial or temporal scaling, they need to be reliable. Otherwise, erroneous motion vectors are more likely to result in additional artifacts being introduced to the scaled image. For each motion vector, it is possible to calculate its motion compensation error by comparing the two associated matching regions in the original frames. Motion compensation error is calculated for each region or block, and is usually expressed as either the mean absolute difference or the mean square error, although certainly other known metrics may be used without departing from the scope of the invention as will be appreciated. Such motion compensation error can be used to estimate a motion vector's reliability: the higher the motion compensation error associated with a motion vector, the less reliable that motion vector is likely to be.

By considering both motion vector reliability and the speed of motion, the method of spatio-temporal video up-scaling according to an embodiment of the present invention determines which one of three spatio-temporal scaling modes should be used:
Mode “E” (high motion error): If motion vectors are considered unreliable (i.e. if they have a large motion compensation error) then they should not be used for scaling. In this case, a single-frame (2D) method should be used for spatial scaling; and frame repetition should be used for temporal scaling. Thus most computational resources should be allocated to spatial scaling.
Mode “F” (fast motion): If motion vectors are considered reliable (i.e. if they have a small motion compensation error) and the speed of motion is fast, then most computational resources should be allocated to temporal scaling. A method of frame rate conversion such as motion-compensated frame interpolation is likely to be effective. In this scenario, an efficient method of spatial scaling should be used, such as bicubic or bilinear scaling, although other methods may be utilized without departing from the scope of the invention as will be appreciated.
Mode “S” (slow motion): If motion vectors are considered reliable (i.e. if they have a small motion compensation error) and the speed of motion is slow, then most computational resources should be allocated to spatial scaling. A multi-frame super-resolution method for spatial scaling is likely to be effective. In this scenario, a computationally-efficient method of temporal scaling should be used—such as simple frame repetition.

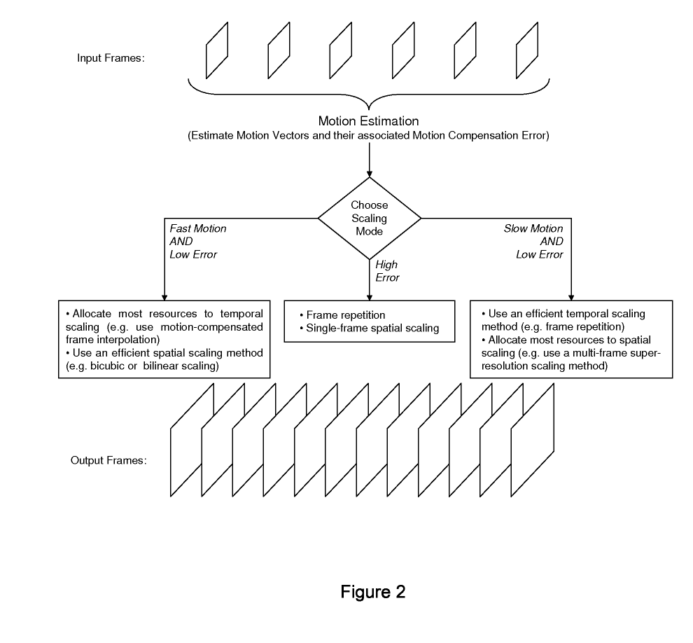

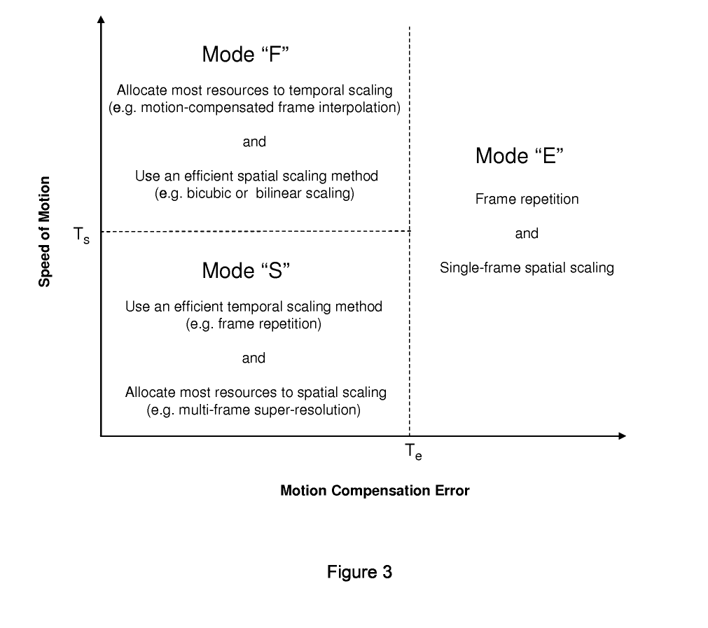

FIG. 2 shows a flowchart which outlines the decision process in accordance with the present invention as described above, and FIG. 3 depicts the three spatio-temporal scaling modes in graphical format.

The method as described above yields one scaling mode for each frame. However, it generalises to the case of one mode per frame region, with a region comprising a group of pixels such as a block of pixels or an object within the scene. In this case, the speed of motion and the motion compensation error should be determined separately for each region.

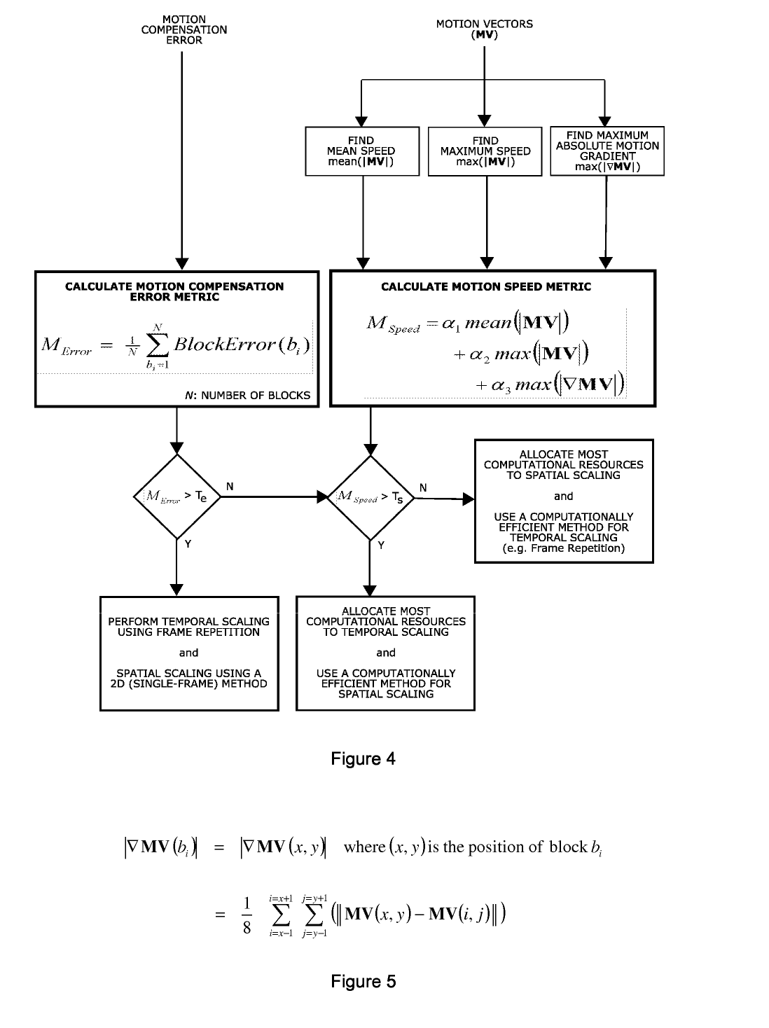

FIG. 4 illustrates the process of determining the motion compensation error and the speed of motion for a frame. The motion compensation error metric, M_{Error} is calculated for each frame (or frame region) as the average motion compensation error for that frame (or region). There are various ways of measuring motion compensation error, the most popular being the mean square error and the mean absolute difference. Both of these methods involve calculating the difference between a block in the current frame and a matching block in the neighbouring frame—with the position of the matching block based on the corresponding motion vector.

The motion speed metric, M_{Speed} is calculated using the estimated motion vectors for a frame (or region), and comprises the weighted sum of three motion terms:
The average motion, mean(|MV|), is the mean of all motion vectors in the frame (or region), and is weighted by the scaling factor α₁.
The maximum motion, max(|MV|), is the magnitude of the largest motion vector within the scene, and indicates the fastest motion present. This term is weighted by the scaling factor α₂.
The maximum motion vector gradient, max(|∇MV|), provides a measure of the maximum relative speed of neighbouring objects within the scene. It is weighted by the scaling factor α₃. FIG. 5 indicates how this value is calculated for each block.

Once the Motion Compensation Error Metric (M_{Error}) and the Motion Speed Metric (M_{Speed}) have been calculated, they can be used to determine the appropriate scaling mode—as illustrated in FIG. 3.

First, M_{Error} is compared to a predefined error threshold, Tₑ. If the metric is larger than this threshold then the motion vectors are considered unreliable, and scaling mode “E” is chosen. However, if M_{Error} is less than or equal to Tₑ then the motion vectors are considered reliable, and one of the other two modes is selected, based on the speed of motion.

The motion speed metric, M_{Speed} is then compared to a predefined speed threshold, Tₛ. If the metric is greater than this threshold then motion is considered fast, and scaling mode “F” is selected. However, if M_{Speed} is less than or equal to Tₛ then scaling mode “S” is chosen.

There are several other useful factors which may be taken into account when defining the thresholds Tₑ and Tₛ:

The threshold Tₛ should be an increasing function of the ratio between the temporal and spatial scaling factors. For example, if video is required to undergo a large amount of spatial scaling, but only a small degree of temporal scaling then computational resources should be biased towards spatial scaling.

Viewing distance may also be used as a factor when determining the appropriate thresholds to use. However, a simple heuristic based on viewing distance is difficult to establish, since decreasing viewing distance increases the visibility of motion compensation artifacts, while simultaneously increasing the need for both temporal and spatial scaling. In general, it is useful to consider the characteristics of the human visual system when considering the effect of viewing distance on the type of scaling to be performed.

Finally, it can also be useful to consider the previously chosen scaling mode when determining the scaling mode for the current frame. This may help to reduce any undesirable sudden changes between scaling modes.

The methods of the present invention as described herein may be carried out within a computer or microprocessor controlled apparatus for performing video up-scaling with respect to an input video. Those having ordinary skill in the art of digital image processing and video up-scaling will understand based on the description herein how to program such a computer or microprocessor controlled apparatus to carry out the steps described herein using any of a variety of conventionally known programming languages. Accordingly, further details regarding the apparatus and the particular programming have been omitted for sake of brevity. The particular program for carrying out the methods described herein is stored in a computer-readable medium preferably within the apparatus or in an external storage medium accessible by the apparatus. The computer-controlled storage medium may include non-volatile memory such as an optical disk or magnetic storage medium (e.g., DVD-ROM, DVD-RW, magnetic hard disk drive, etc.). Alternatively, such program may be stored in ROM, EEPROM or the like. Further, such program may be stored in volatile memory such as RAM or the like. The program is read and executed by the computer or microprocessor and as a result performs the methods described herein.

Furthermore, it will be appreciated that such a computer or microprocessor controlled apparatus for performing video up-scaling in accordance with the present invention will have a particular amount of computational resources available at any given time. By carrying out the methods described herein in accordance with the present invention, the computational resources are allocated more optimally within the apparatus.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A method of performing spatio-temporal up-scaling, comprising:
receiving an input video comprising a sequence of input frames,
analyzing the input video to estimate motion vectors associated with the sequence of input frames, and determining corresponding motion compensation errors associated with the motion vectors;
determining an extent to which computational resources are to be respectively allocated to spatially up-scaling the sequence of input frames and temporally up-scaling the sequence of input frames, based on the estimated motion vectors and corresponding motion compensation errors; and
spatio-temporally up-scaling the sequence of input frames based on the determined extent.

2. The method of claim 1, wherein when the motion vectors and corresponding motion compensation errors are indicative of relatively fast motion and small motion compensation error, the computational resources are biased towards temporal up-scaling.

3. The method of claim 1, wherein when the motion vectors and corresponding motion compensation errors are indicative of relatively slow motion and small motion compensation error, the computational resources are biased towards spatial up-scaling.

4. The method of claim 1, wherein when the corresponding motion compensation errors are indicative of relatively large motion compensation error, the computational resources are biased towards spatial up-scaling.

5. The method of claim 1, wherein the extent is determined frame-by-frame for the sequence of input frames.

6. The method of claim 1, wherein the extent is determined region-by-region within a given frame in the sequence of input frames.

7. The method of claim 1, wherein the motion vectors are estimated using at least one of block matching, phase correlation and gradient-based techniques.

8. The method of claim 2, wherein the computational resources are biased towards temporal up-scaling by applying motion-compensated frame interpolation for temporal up-scaling, and at least one of bicubic or bilinear scaling for spatial up-scaling, in the spatio-temporal up-scaling step.

9. The method of claim 3, wherein the computational resources are biased towards spatial up-scaling by applying multi-frame super resolution for spatial up-scaling, and frame repetition for temporal up-scaling, in the spatio-temporal up-scaling step.

10. The method of claim 4, wherein the computational resources are biased towards spatial up-scaling by applying single-frame spatial up-scaling for spatial up-scaling, and frame repetition for temporal scaling, in the spatio-temporal up-scaling step.

11. The method of claim 1, wherein the determining step comprises selecting a spatio-temporal up-scaling mode for the spatio-temporal up-scaling step from among a plurality of different predefined spatio-temporal up-scaling modes, based on the estimated motion vectors and corresponding motion compensation errors.

12. The method of claim 11, wherein each of the plurality of different predefined spatio-temporal up-scaling modes comprises a different combination of spatial up-scaling and temporal up-scaling methods.

13. The method of claim 11, wherein at least one of the plurality of different predefined spatio-temporal up-scaling modes utilizes motion estimation for at least one of spatial up-scaling and temporal up-scaling, and another of the plurality of different predefined spatio-temporal up-scaling modes does not utilize motion estimation.

14. The method of claim 13, wherein selection between the at least one predefined spatio-temporal up-scaling mode and the another predefined spatio-temporal up-scaling mode is based on whether the corresponding motion compensation error exceeds a predefined error threshold value.

15. The method of claim 1, wherein the corresponding motion compensation errors associated with the motion vectors are calculated using at least one of mean square error and mean absolute difference techniques.

16. The method of claim 11, wherein the analyzing step comprises calculating a motion speed metric using the motion vectors, and selection between the different predefined spatio-temporal up-scaling modes is based on whether the corresponding motion speed metric exceeds a predefined speed threshold value.

17. The method of claim 16, wherein the motion speed metric is based on at least one of average motion, maximum motion and maximum motion vector gradient of motion vectors in a given frame or region within the sequence of input frames.

18. A computer program comprising code stored on a computer-readable medium which, when executed by a computer, causes the computer to carry out the steps of:
receiving an input video comprising a sequence of input frames,
analyzing the input video to estimate motion vectors associated with the sequence of input frames, and determining corresponding motion compensation errors associated with the motion vectors;
determining an extent to which computational resources are to be respectively allocated to spatially up-scaling the sequence of input frames and temporally up-scaling the sequence of input frames, based on the estimated motion vectors and corresponding motion compensation errors; and
spatio-temporally up-scaling the sequence of input frames based on the determined extent.

19. A method of performing spatio-temporal up-scaling, comprising:
receiving an input video data comprising a sequence of input frames;
performing a combination of spatial up-scaling and temporal up-scaling to the sequence of input frames; and
modifying the combination dynamically as a function of at least one property of the sequence of input frames.

20. The method of claim 19, wherein the at least one property comprises motion exhibited in the sequence of input frames.
